(19) United States
(12) Patent Application Publication
(10) Pub. No.: US 2010/0121498 A1
(43) Pub. Date: May 13, 2010

(54) SYSTEM FOR COLLECTING ENERGY TO IDENTIFY WITH AN OBJECT OF INTEREST

(76) Inventor: KIRKLAND R. GABLE, Thousand Oaks, CA (US)

Correspondence Address: KOPPEL, PATRICK, HEYBL & DAWSON, 2815 Townsgate Road, SUITE 215, Westlake Village, CA, 91361-5827, US

(21) Appl. No.: 12/463,327

(22) Filed: May 8, 2009

Related U.S. Application Data
(60) Provisional application No. 61/051,631, filed on May 8, 2008.

(51) Int. Cl. G06F 19/00

(52) U.S. Cl. 700/286

(57) ABSTRACT

An Identifiable Energy Storage Media (IESM) device includes a representation of an object and a battery connected to the representation, the battery having stored energy collected from the object. The IESM device may also include a playback module connected to the battery to highlight the representation of the object using energy identified and stored in the battery.

This application claims benefit of Provisional Application Ser. No. 61/051,631, filed May 8, 2008.

### BACKGROUND OF THE INVENTION

1. Field of the Invention

This invention relates to the storage and use of energy. More particularly, the present invention relates to identification of an object of interest, collection of energy from the object of interest and utilization of the identified, collected energy to highlight the object of interest.

2. Description of the Related Art

There are many individually identifiable sources of energy in the environment. These identifiable sources can be people, animals, and plants, inanimate forces such as the wind, sun, or ocean waves, or physical objects in motion. Identifiable sources of energy may include multiple point sources of energy, such as a number of identifiable objects found in a particular outdoor location having wind, sun and physical objects acting as reflectors for each.

Such identifiable sources of energy have multiple uses. Energy storage devices, such as a batteries or capacitors, may collect energy converted from the electromagnetic or kinetic energy provided by the identifiable objects to then drive sound speakers, sources of artificial light such as LEDs, and even smell generators that blend stored chemicals to emit a variety of fragrances. For example, it is now common to identify the sun as a source of electromagnetic energy and to collect a portion of that energy in a battery by way of conversion from electromagnetic energy to chemical electric charge for accumulation in a battery. Such collected energy may then be extracted by a lamp circuit to provide illumination in the evening hours or to power other electrical apparatus.

Although the utilitarian value of energy collected and stored in a battery is seen in the many electrical appliances, vehicles and tools of everyday life, a need continues to exist to use such energy to enhance emotional experiences in other contexts such as in entertainment, educational, religious, healing and inter-personal relationships.

### SUMMARY OF THE INVENTION

An Identifiable Energy Storage Media (IESM) device is disclosed that includes a representation of an object and a battery connected to the representation, the battery having stored energy generated from the object.

In one embodiment of the invention, a method is disclosed that includes identifying an object of interest, collecting energy generated from the object of interest, storing the electrical energy in a battery, capturing a representation of the object of interest, placing the representation and the battery in a display device, and highlighting the representation of the object of interest using electrical energy collected from the object of interest.

### BRIEF DESCRIPTION OF THE DRAWINGS

The components in figures are not necessarily to scale emphasis instead being placed upon illustrating the principals of the invention. Like reference numerals designate corresponding parts throughout the different views.

FIG. 1 is a block diagram of an embodiment illustrating a photovoltaic cell to a battery to collect energy from an object of interest;

FIG. 2 is a block diagram of an embodiment illustrating an LED light connected to the battery to illuminate a photograph of the object of interest using energy stored in the battery;

FIG. 3 is a flow diagram of one embodiment that illustrates identifying an object of interest, generating energy from the object of interest and storing the energy for later use;

FIG. 4 is a flow diagram of one embodiment that illustrates use of stored energy to eliminate a representation of an object;

FIG. 5 is a schematic diagram of one embodiment of a visual display unit configured to collect energy generated from an object of interest;

FIG. 6 is one embodiment of a schematic illustrating a visual display unit configured to highlight a representation of an object of interest using illumination from a light source.

### DETAILED DESCRIPTION OF THE INVENTION

An apparatus, in accordance with one embodiment of the invention, includes a representation of an object of interest and a battery connected to the representation, the battery having stored therein energy collected from the object of interest. Although the description which follows refers to a single “object of interest,” such as an individual football or basketball player, it is understood that an “object of interest” may include many individual objects of interest forming a collective “object of interest” for energy collection, such as would be found with collection of radiated and reflected sunlight at particular geographic location on a sunny day.

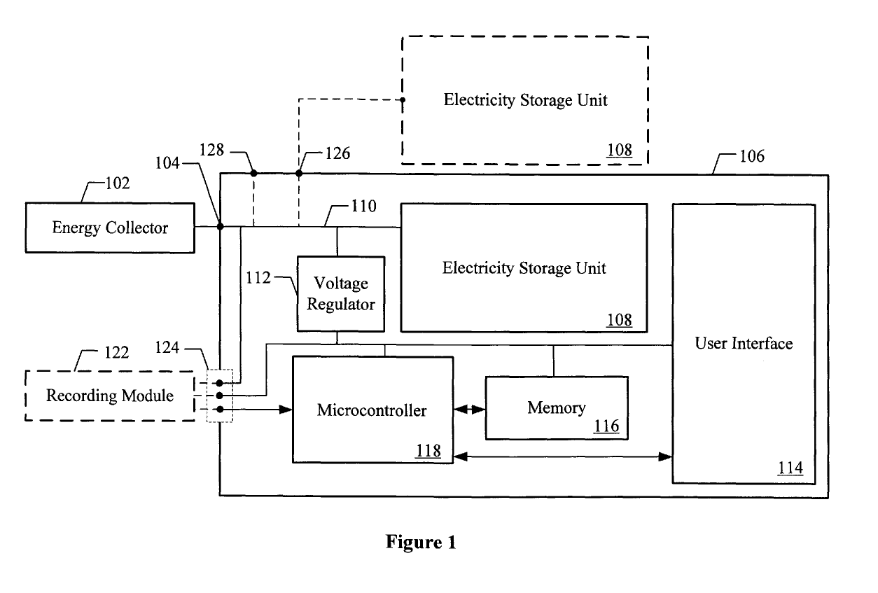

FIG. 1 illustrates one embodiment of the Identifiable Energy Storage Media (IESM) device, preferably a display unit 100, for collecting energy from an object of interest for storage in a battery. The display unit 100 has an energy collector 102 detachably connected to a power terminal 104 on a housing 106. The power terminal 104 is in electrical communication with a battery 108 through a power supply line 110 so that the battery 108 may collect energy provided by energy collector 102. In the illustrated embodiment, the energy collector is preferably a photovoltaic cell to convert electromagnetic energy generated by or reflected off of an object of interest (not shown) to a current to charge the battery 108. In an alternative embodiment, the energy collector 102 may be a Ferraday device, piezoelectric device, microphone or other electronic device useful for converting linear motion, elastic deformation or acoustic wave energy, respectively, to an electric current for collection of the energy in a battery. Examples of a Ferraday device include a linear electrical generator, a flywheel apparatus attached to a dynamo or other device suitable for converting mechanical energy into electrical energy so as to convert and collect, for example, the motion of a person into energy for storage in the battery 108.

A voltage regulator 112 is connected to the power supply line 110 to maintain an approximately constant line voltage to charge the battery 108. The output of voltage regulator 112 is electrically connected to a user interface 114, memory 116 and microcontroller 118 through device supply line 120 to provide operating power to such components (114, 116, 118). The user interface 114 enables user control of energy collection timing, such as “start collection” and “stop collection.” In a preferred embodiment, the user interface 114 includes a push button to provide an indication for the microcontroller 118 to initiate collection of energy through energy collector 102.

In an alternative embodiment, a recording module 122 is detachably connected to the housing 106 through collection module terminal 124 and is in electrical communication with microcontroller 118 to receive control commands, power supply line 110 for “recording” user feedback (such as with a blinking LED light) and device supply line 120 for operating power. The recording module receives data associated with collection of energy at energy collector 102. In a preferred embodiment, the recording module 122 is a light sensor to measure light amplitude over time and includes a recording LED (not shown) to indicate that recording is taking place. In such an embodiment, the microcontroller 118 receives light amplitude data for storage in memory 114 to enable subsequent retrieval by a user. Alternatively, the recording module 122 may consist of more than one light sensors used in combination and filtered with spectral filters to gather data relating to amplitude in different spectral regions over time to enable subsequent use of colored or tinted light sources.

Although the battery 108 is illustrated as contained within the housing 106, in an alternative embodiment, the battery is detachably connected to the housing 106 at battery terminal 126 to allow the collected energy to be used in a different device. Also, although only a single energy collector 102 is illustrated, in an alternative embodiment, a secondary battery (not shown) or energy source may be provided through an auxiliary power terminal 128 to supplement power collected and stored in the battery 108.

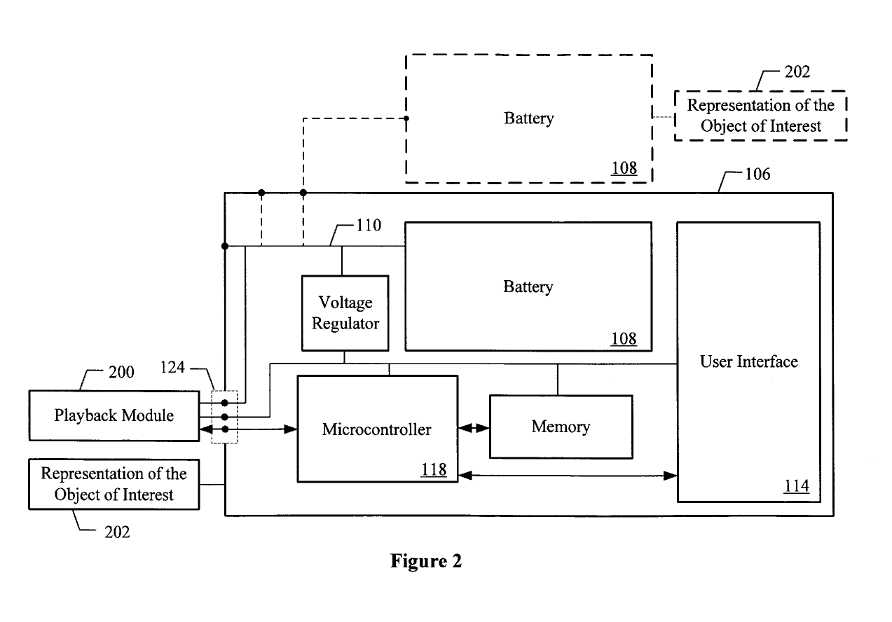

FIG. 2 illustrates a block diagram of one embodiment that has a playback module detachably coupled to a battery in a display device that may be used to highlight a representation of an object of interest. In this embodiment, the recording module (See FIG. 1) is removed and replaced with a playback module 200 detachably coupled at collection module terminal 124 to the display device 106. The playback module 200 is in electrical communication with the battery 108 through power supply line 110. The playback module 200 is preferably a light source such as an LED, positioned in complementary opposition to a representation of on object of interest 202. Or, the playback module may be a speaker, scent machine or other apparatus that enables a user to associate power previously collected in the battery 108 with an associated representation of the object of interest. The playback module 200 is in electrical communication with microcontroller 118 to receive a playback command, such as a control command indicating “lamp on” or “lamp off.” In a preferred embodiment, the representation of an object of interest is a photograph of a person or place from which the energy in the battery was collected and the photograph may be illuminated by the LED light in the playback module 200. Alternatively, the representation may be a physical sample of the object of interest, such as sand from a beach, a patch from a uniform or other indicia of the origin of the collected energy.

In an alternative embodiment, the representation of the object of interest 202, such as a photograph, signature or physical sample, is placed on or coupled directly to the battery 108 having stored energy generated from the object. In this embodiment, the representation is preferably not highlighted by a playback module, but may exist apart from the playback module to provide power to another apparatus such as a watch, flashlight or other electrical device.

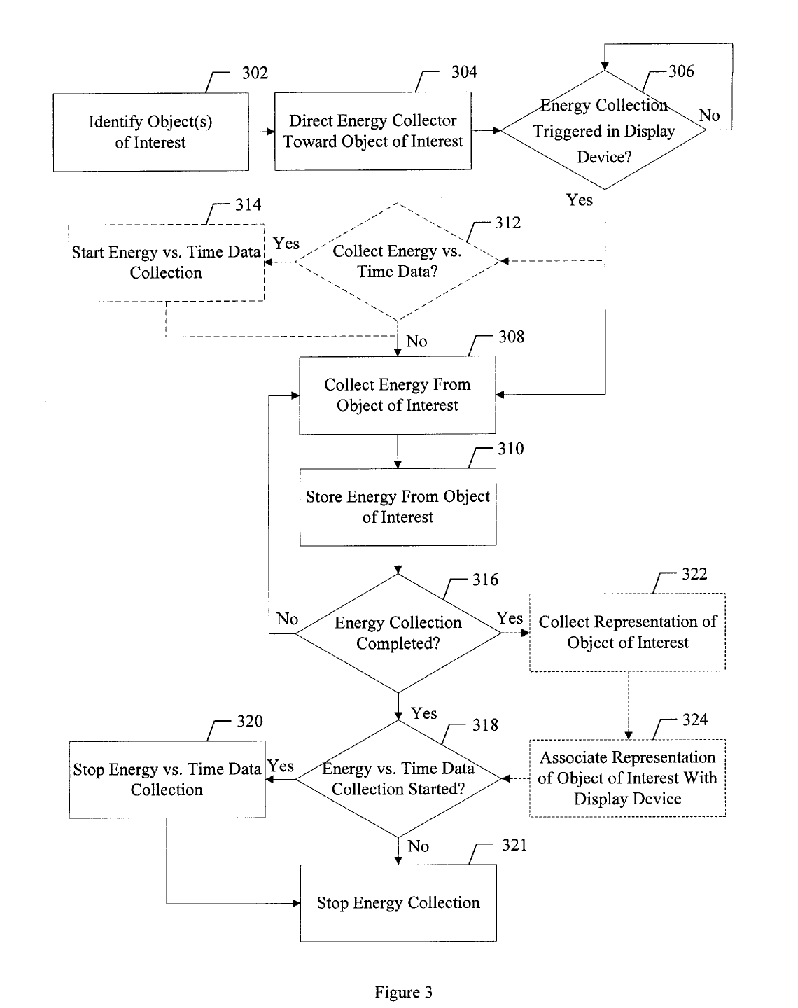

FIG. 3 is a flow diagram illustrating one embodiment of a method for collecting energy from an object of interest. An object of interest is identified (block 302) and an energy collector directed toward (such as for use with a photovoltaic cell) or coupled to (such as for use with a Faraday or piezoelectric device) the object of interest (block 304). If the user triggers the display device to start energy collection (block 306), energy collection begins (block 308) and is stored in an electricity storage unit, preferably a battery (block 310). In an alternative embodiment, if energy versus time data is collected (block 312), then energy versus time data collection is started (block 314) and energy collection begins (block 308). Preferably after energy collection is completed (block 316), the microcontroller (not shown) determines whether or not energy versus time data collection was initiated (block 318), stops such data collection if necessary (block 320), and energy collection stops (block 320). In an alternative embodiment, a representation of the object of interest is collected (block 322), preferably a photograph, sound or scent recording of the object of interest, and a representation is subsequently associated with the display device (block 324) such as by physically attaching the representation to the display device (not shown) if such representation is a tangible object suitable for physical attachment.

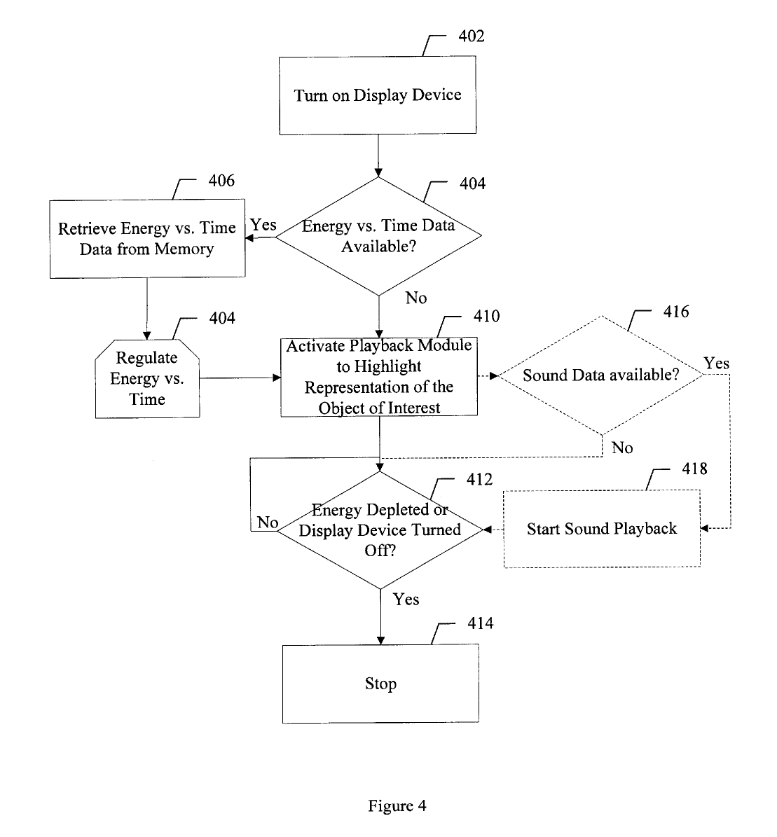

FIG. 4 illustrates a flow diagram of one embodiment using a display device to highlight a representation of the object of interest using energy collected from the same object of interest. The display device is turned on (block 402) through the user interface (not shown). If energy versus time data is available (block 404), the data is retrieved from memory (block 406) and energy provided the battery (not shown) is regulated versus time (block 408) to drive a playback module (block 410) to highlight the representation of the object of interest, preferably illuminating said object of interest using LEDs. When the display device is either turned off either by the user through the user interface or by operation of battery depletion, (block 412), the playback module ceases highlighting (block 414) the representation. In an alternative embodiment, if sound data is available (block 416), the playback module 410 is activated (block 410) and sound playback begins (block 418).

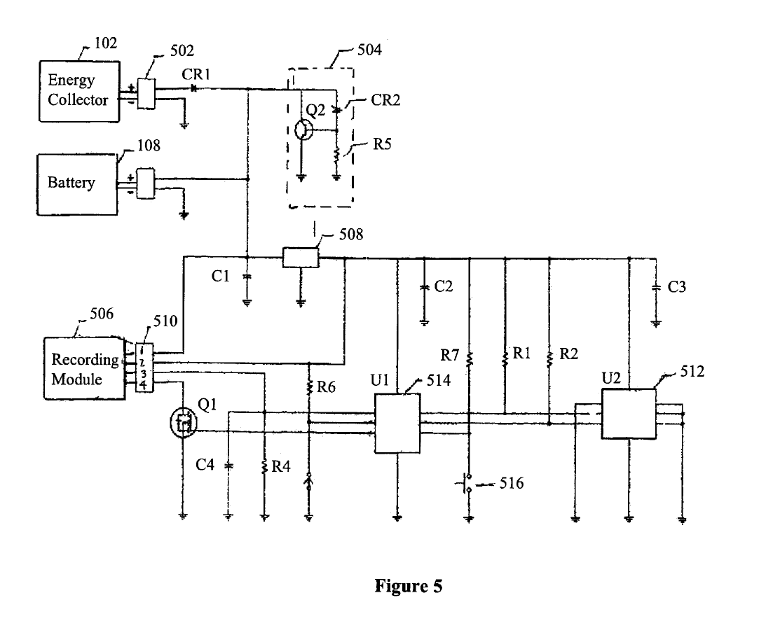

FIG. 5 illustrates one implementation of the display device illustrated in FIG. 1 configured for an energy collection and recording mode. Energy collector 102 preferably a photovoltaic cell, is connected to charger terminal 502 for communication of current to battery 108. Shunt voltage regulator 504 is connected to charger terminal 502 to set the maximum collection voltage, preferably to 5.1 volts. A recording module, preferably light sensor 506, is coupled to voltage regulator 508 through collection module terminal 510 to receive power for operation. Light sensor 506 is operable to sample energy, in the form of light amplitude over time, for communication to non-volatile memory 512 for storage through microcontroller 514. Preferably, collection module terminal 510 includes a recording LED across terminals 1 and 4 of collection module terminal 510 to flash once per second to indicate that recording is taking place. A user interface, preferably push button 516 is connected to the microcontroller 514 to selectively initiate energy collection.

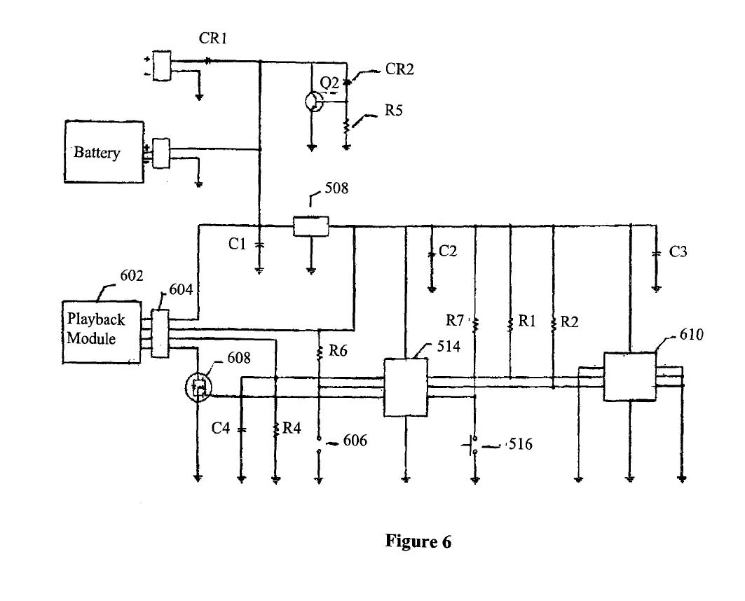

In one display unit designed for use with a photovoltaic cell, the various elements of the display unit have the characteristics listed in Table 1 (See FIGS. 5 and 6).

| | Characteristic | | Designation/Part Name |
|---|---|---|---|
| CR1 | na | | 1N4001 |
| CR2 | 5.1 | V | 1N5231 (Zener diode) |
| Q1 | na | | IRFZ34N (MOSFET) |
| Q2 | na | | 2N4401 (MOSFET) |
| C1 | 220 | | na |
| C2 | 0.1 | | na |
| C3 | 0.1 | | na |
| C4 | 10 | | na |
| R1 | 4.7K | ohm | na |
| R2 | 4.7K | ohm | na |
| R4 | 10K | ohm | na |
| R5 | 10K | ohm | na |
| R6 | 100K | ohm | na |

| | | |
|---|---|---|
| U1 | NA | PIC12F683 (Flash Microcontroller) |
| U2 | NA | 24LC256 (PROM) |

FIG. 6 is a schematic diagram illustrating one implementation of the display device illustrated in FIG. 2 and configured for a playback mode. During playback mode, the energy and energy data obtained during recording mode is used to highlight a representation of an object of interest. In this configuration, the recording module 506 and energy collector 102 are removed (see FIG. 5) and the recording module is replaced with a playback module 602 detachably coupled to a playback module terminal 604, preferably on LED light. A jumper 606 is removed and pushbutton 516 disengaged. Although illustrated as an LED 602, the LED may be replaced by any suitable light source such as a standard filament-based bulb or fluorescent light source. Preferably, the light source would be capable of varying intensities for control by the microcontroller 514. For example, the amplitude of illumination of the LED's 602 is controlled by a MOSFET 608 controlled by microcontroller 514 with reference to energy versus time data provided from memory 610. A representation of the object of interest, preferably a photograph (not shown) is illuminated by the illuminating LED's 602, preferably with the same intensity of light minute by minute as the energy was collected during the recording mode (see FIG. 3). By way of example for the described implementation of FIG. 6, the display unit 100 may collect solar energy from an endangered landscape in Maui from 1:00 PM to 1:30 PM in the afternoon as scattered clouds pass overhead. Subsequently, the display unit 100 would show the photographed representation of the landscape as it darkened, brightened, and then darkened, while a clock on the user interface of the display unit 100 would show the time when the changes occurred. With the additional recording of spectral shifts provided by a plurality of light sensors in a recording module 506, each sensor with a respective light filter to isolate predetermined spectral ranges.

While various implementations of the application have been described, it will be apparent to those of ordinary skill in the art that many more embodiments and implementations are possible that are within the scope of this invention.

I claim:

1. A method, comprising:
identifying an object of interest;
collecting energy generated from the object of interest;
storing said electrical energy in a battery;
capturing a representation of the object of interest; and
placing said representation of the object of interest and said battery in a display device.

2. The method according to claim 1, further comprising:
highlighting said representation of the object of interest using electrical energy collected from said object of interest.

3. The method according to claim 2, wherein said highlighting comprises illuminating said representation with a light source.

4. The method according to claim 2, wherein said highlighting comprises reproducing said representation using a video.

5. The method according to claim 2, wherein said highlighting comprises reproducing said representation in sound.

6. The method according to claim 1, wherein said capturing a representation comprises collecting a physical sample of the object of interest.

7. The method according to claim 1, further comprising:
collecting data indicating energy verses time for said converting;

8. The method according to claim 7, further comprising:
varying said highlighting over time according to said collected data indicating energy verses time.

9. The method according to claim 1, wherein said collecting energy from said object of interest comprises converting mechanical motion of said object of interest to electrical energy using a faraday device connected to said object of interest.

10. The method according to claim 1, wherein said collecting energy from said object of interest comprises converting mechanical motion of said object of interest to electrical energy using a piezoelectric device connected to said object of interest.

11. The method according to claim 1, wherein said collecting energy comprises converting electromagnetic energy reflected off of said object of interest.

12. The method according to claim 1, wherein said collecting energy further comprises driving energy through said object of interest prior to said collecting.

13. An apparatus, comprising:
a battery;
an energy collector connected to said battery to collect energy from an object;
a representation of the object; and
a playback module to highlight said representation of the object using energy stored in said battery.

14. The apparatus of claim 13, wherein said energy collector comprises a photovoltaic cell to collect electromagnetic radiation.

15. The apparatus of claim 14, wherein said representation of said object comprises a photograph.

16. The apparatus of claim 15, wherein said playback module comprises a light to illuminate said photograph.

17. The apparatus of claim 13, wherein said energy collector is a piezoelectric cell to transform bending moment into energy.

18. The apparatus of claim 13, wherein said energy collector is a Faraday cell to transform movement into energy.

19. The apparatus of claim 13, wherein said energy collector is a wind generator.

20. The apparatus of claim 13, further comprising a power terminal to receive supplemental power to power said playback module.

21. The apparatus of claim 13, wherein said playback module is a multimedia player.

22. An apparatus, comprising:
a battery having stored energy generated from an object of interest; and
a representation of said object of interest positioned on said battery.

23. The apparatus of claim 22, further comprising:
a playback module connected to said battery to highlight said representation of the object using energy stored in said battery.

24. The apparatus of claim 23, wherein said tangible representation of the object is a photograph.

25. The apparatus of claim 24, wherein said playback module comprises a light.
